(19) United States
(12) Patent Application Publication
(10) Pub. No.: US 2026/0277618 A1
(43) Pub. Date: Sep. 17, 2026

(54) PROCESSOR FREQUENCY CONTROL METHOD AND ELECTRONIC DEVICE USING THE PROCESSOR FREQUENCY CONTROL METHOD

(71) Applicant: MEDIATEK INC., Hsinchu City (TW)

(72) Inventors: Ching-Hao Hsu, Hsinchu City (TW); Chien-Chih Yeh, Hsinchu City (TW); Jia-Wei Lin, Hsinchu City (TW); Po-Shau Chen, Hsinchu City (TW)

(73) Assignee: MEDIATEK INC., Hsinchu City (TW)

(21) Appl. No.: 19/077,019

(22) Filed: Mar. 11, 2025

(51) Int. Cl. G06F 9/4401

(52) U.S. Cl. CPC G06F 9/4403

(57) ABSTRACT

A processor frequency control method, for controlling a first processor frequency of a first processor of an electronic device, comprising: (a) applying a first frequency ceiling to the first processor frequency in a booting time interval, wherein the electronic device boots during the booting time interval; and (b) changing the first frequency ceiling to a second frequency ceiling higher than the first frequency ceiling; wherein the first frequency ceiling and the second frequency ceiling are lower than a maximum processor frequency of the processor.

### BACKGROUND

The present application relates to a processor frequency control method and an electronic device, and particularly relates to a processor frequency control method which can avoid instantaneous high power consumption of a CPU (Central Processing Unit) and an electronic device using the processor frequency control method.

In the related art, when the electronic device is booting (or named powered on), the CPU frequency of its CPU can be controlled at a more appropriate value through a frequency adjusting process. However, before the frequency adjusting process is performed, the CPU may have an instantaneous high CPU frequency (or named a peak CPU frequency). In such state, the electronic device may have a high power consumption. Also, when the instantaneous high power consumption caused by the CPU exceeds the maximum power load of the electronic device (e.g., an extremely large current is drained form a battery), the electronic device may not boot smoothly.

FIG. 1 is a schematic diagram illustrating the peak CPU frequency issue of related art. As illustrated in FIG. 1, during the booting time interval T_b, a booting action is performed, and the CPU frequency may reach a maximum CPU frequency F_M first. Then, the CPU frequency is controlled to be lower than a limited CPU frequency FC_L after the frequency adjusting process is performed. As above-mentioned, the electronic device may have a high power consumption if the CPU operates at the maximum CPU frequency F_M. Also, when the instantaneous high power consumption caused by the CPU exceeds the maximum power load of the electronic device (e.g., an extremely large current is drained form a battery), the electronic device may not boot smoothly.

The operations of the CPU may correspond to an OPP (Operating Performance Points) table OP_T which comprises a plurality of CPU levels OPP0 . . . OPP4. The CPU may operate at a different frequency and a different supply voltage corresponding different CPU levels. The maximum CPU frequency F_M corresponds a maximum CPU level OPP0, and the limited CPU frequency F_L corresponds to a CPU level OPP2 lower than the maximum CPU level OPP0.

### SUMMARY

One objective of the present application is to provide a processor frequency control method which can avoid the instantaneous maximum power consumption during the booting action.

Another objective of the present application is to provide an electronic device which can avoid the instantaneous maximum power consumption during the booting action.

One embodiment of the present application provides a processor frequency control method, for controlling a first processor frequency of a first processor of an electronic device, comprising: (a) applying a first frequency ceiling to the first processor frequency in a booting time interval, wherein the electronic device boots during the booting time interval; and (b) changing the first frequency ceiling to a second frequency ceiling higher than the first frequency ceiling; wherein the first frequency ceiling and the second frequency ceiling are lower than a maximum processor frequency of the processor.

Another embodiment of the present application provides an electronic device, comprising: a first processor, configured to perform following steps: (a) applying a first frequency ceiling to the first processor frequency in a booting time interval, wherein the electronic device boots during the booting time interval; and (b) changing the first frequency ceiling to a second frequency ceiling higher than the first frequency ceiling; wherein the first frequency ceiling and the second frequency ceiling are lower than a maximum processor frequency of the processor.

In view of above-mentioned embodiments, the CPU frequency of at least one CPU may be limited below a proper frequency during a booting action. By this way, the instantaneous maximum power consumption of the CPU during the booting action can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the peak CPU frequency issue of related art.

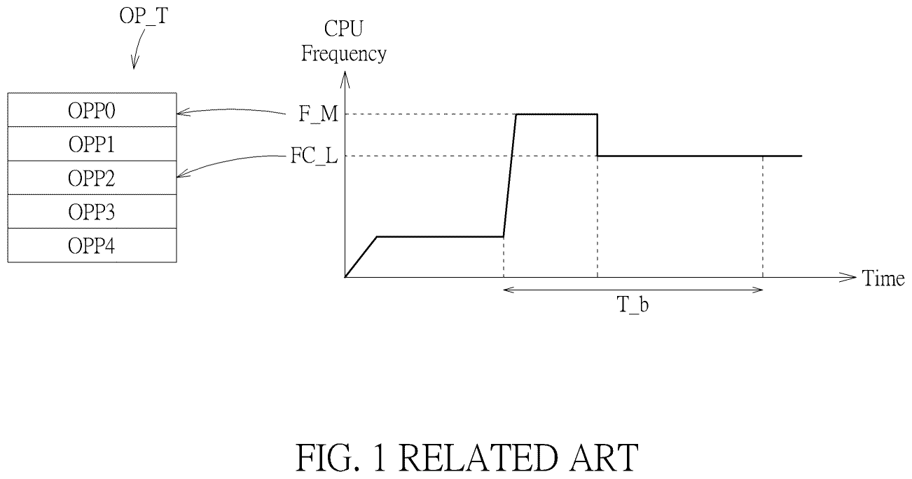

FIG. 2 is a block diagram illustrating an electronic device according to one embodiment of the present application.

FIG. 3 is a schematic diagram illustrating a first CPU frequency of the embodiment shown in FIG. 2.

FIG. 4 is a block diagram illustrating an electronic device according to another embodiment of the present application.

FIG. 5 is a schematic diagram illustrating a second CPU frequency of the embodiment shown in FIG. 4.

FIG. 6 illustrates a flow chart of tuning the first maximum frequency and a flow chart of practical operations of the electronic device, according to embodiments of the present application.

FIG. 7 is a flow chart illustrating a processor frequency control method, according to one embodiment of the present application.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices. Further, in following embodiments, CPUs are used as examples for explaining. However, the CPUs may be replaced by any other processors.

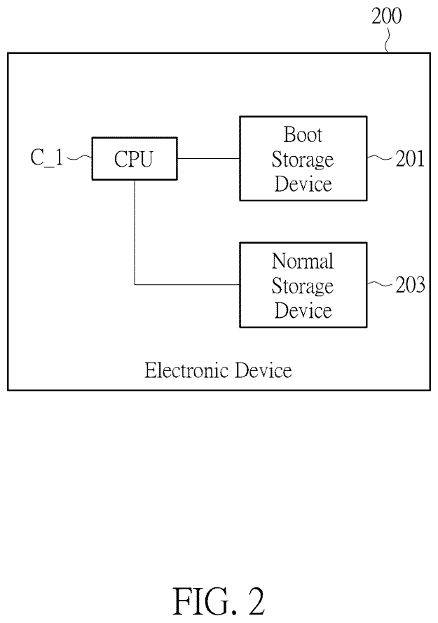

FIG. 2 is a block diagram illustrating an electronic device 200 according to one embodiment of the present application. As shown in FIG. 2, the electronic device 200 comprises a first CPU C_1, a boot storage device 201 and a normal storage device 203. The electronic device 200 may be any kind of electronic device. For example, the electronic device 200 can be a desktop computer, a laptop computer, a tablet computer, or a mobile device. If the electronic device 200 receives a booting instruction (e.g., a power on button of the electronic device is triggered) when it is turned off, the electronic device 200 starts to boot in a booting time interval. However, the booting action may be triggered by another method. For example, the booting action may be triggered by receiving a rebooting instruction.

The first CPU C_1 may read the information (e.g., programs or data) stored in the boot storage device 201 for booting. The boot storage device 201 may be, for example, a ROM (Read Only Memory). After the booting action of the electronic device has been completed, the first CPU C_1 may read the information stored in the normal storage device 203 to control the electronic device 200. The normal storage device 203 can be, for example, a flash memory or a hard disk. In one embodiment, an OS (operation system) such as windows, android or IOS is installed to the normal storage device 203. After the booting action of the electronic device has been completed, the first CPU C_1 may control the electronic device 200 via the OS.

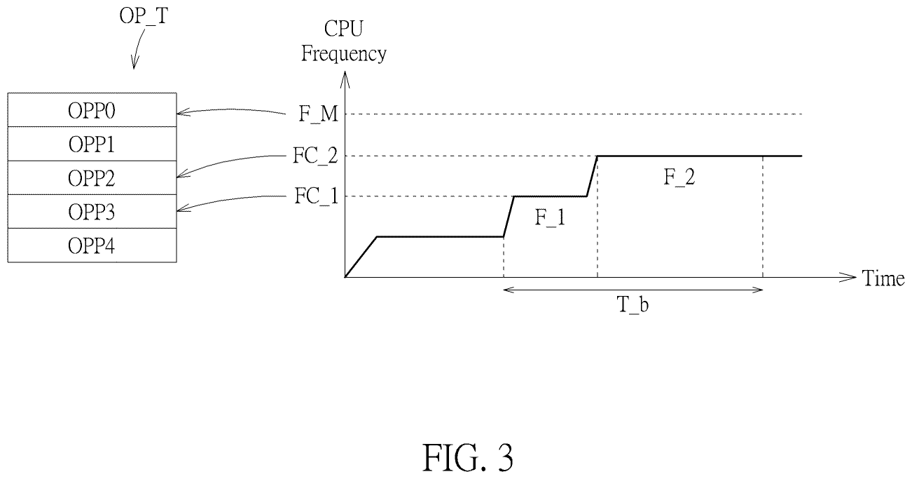

FIG. 3 is a schematic diagram illustrating a first CPU frequency of the embodiment shown in FIG. 2. In the embodiment of FIG. 3, the horizontal axis represents time, and the vertical axis represents the CPU frequency. The supply voltage of the first CPU C_1 may vary corresponding to the variation of the first CPU frequency. For example, the supply voltage of the first CPU C_1 increases corresponding to the increment of the first CPU frequency. In one embodiment, the first CPU C_1 may operate in different CPU levels comprised in the OPP table OP_T, the CPU levels correspond to different combinations of first CPU frequencies and supply voltages. However, the adjustment of the first CPU frequency is not limited to be performed by using the OPP table OP_T. In following embodiments, the OPP table OP_T comprises four CPU levels. However, the OPP table OP_T may comprises other numbers of CPU levels. Also, the OPP table may not comprise the CPU levels, but the CPU level is the frequency defined in the OPP table.

In the embodiment of FIG. 3, the electronic device 200 is initially turned off, in which the first CPU frequency may be zero, but such state is not illustrated in FIG. 3. After receives a booting instruction, the electronic device 200 boots in the booting time interval T_b, and a booting action of the electronic device 200 has been completed after the booting time interval T_b. In the booting time interval T_b, the first CPU frequency of the first CPU C_1 is a first frequency F_1 which is limited to be lower or equal to a first frequency ceiling FC_1. The first CPU frequency may be a second frequency F_2 which is limited by a second limited by the first frequency ceiling FC_1 after the frequency adjusting process is performed. The second frequency F_2 may also be limited to be lower than or equal to a second frequency ceiling FC_2. In following embodiments, the first CPU frequency transits from the first frequency F_1 to the second frequency F_2 in the booting time interval T_b. However, in another embodiment, the first CPU frequency transits from the first frequency F_1 to the second frequency F_2 after the booting time interval T_b.

The first frequency ceiling FC_1 may be equal to or smaller than the second frequency ceiling FC_2. Also, the first frequency ceiling FC_1 and the second frequency ceiling FC_2 are lower than a maximum CPU frequency F_M of the first CPU C_1. In one embodiment, the maximum CPU frequency F_M, the first frequency ceiling FC_1 and the second frequency ceiling FC_2 correspond to different CPU levels of the OPP table OP_T.

In the embodiment of FIG. 3, the first frequency ceiling FC_1 is lower than the second frequency ceiling FC_2. Accordingly, the first frequency ceiling FC_1 corresponding to a CPU level OPP3 lower than a CPU level OPP2 which the second frequency ceiling FC_2 corresponds to. Also, the maximum CPU frequency F_M corresponds to a maximum CPU level OPP0. However, if the first frequency ceiling FC_1 is equal to the second frequency ceiling FC_2, the first frequency ceiling FC_1 and the second frequency ceiling FC_2 may correspond to the same CPU level.

The frequency adjusting process may control the first CPU frequency according to different considerations. For example, the frequency adjusting process may control the first CPU frequency according to the actions of the electronic device 200 or the tasks processed by the electronic device 200, but not limited. In one embodiment, the frequency adjusting process is a DVFS (Dynamic Voltage and Frequency Scaling) for a CPU. Further, in another embodiment, the above-mentioned OS is not activated and cannot be used to control the electronic device 200 during the booting time interval T_b, since the booting action is not completed yet. However, the OS is activated and is used to control the electronic device 200 after the booting action has been completed.

The first frequency ceiling FC_1 may be set according to various requirements. For example, the first frequency ceiling FC_1 may be set to ensure that the electronic device 200 can smoothly boot. For another example, the first frequency ceiling FC_1 can be set to ensure that the electronic device 200 can operate as expected after booting. For still another example, the first frequency ceiling FC_1 may be set to ensure that the power system of the electronic device 200 is sufficient to support the booting operations.

Besides the first frequency ceiling FC_1, the first CPU frequency can further be limited to the first frequency F_1 higher than a first minimum frequency. The first minimum frequency may be set according to various requirements. For example, the first minimum frequency may be set to ensure that the electronic device 200 can smoothly boot. In one embodiment, the first minimum frequency may correspond to a minimum CPU level of the OPP table OP_T.

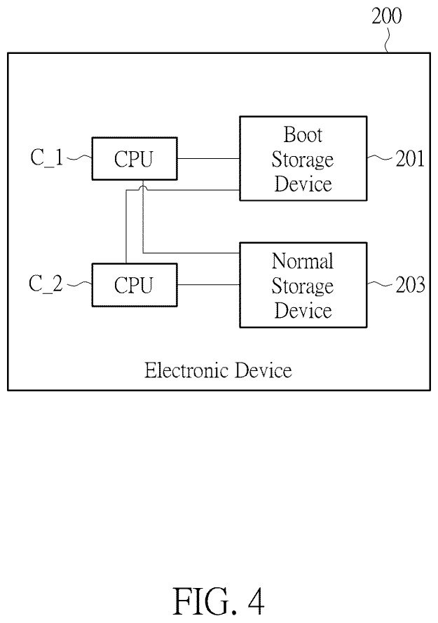

The electronic device 200 may comprise more than one CPUs. FIG. 4 is a block diagram illustrating an electronic device 200 according to another embodiment of the present application. As shown in FIG. 4, besides the first CPU C_1, the boot storage device 201 and the normal storage device 203 stated in FIG. 2, the electronic device 200 further comprises a second CPU C_2. In one embodiment, the first CPU C_1 and the second CPU C_2 are different types of cores. For example, the first CPU C_1 is a big core and the second CPU C_2 is a little core.

In one embodiment, the first CPU C_1 and the second CPU C_2 may perform the booting action together. In such case, if the booting action is triggered as above-mentioned, the electronic device 200 starts to boot in a booting time interval. The second CPU C_2 may read the information stored in the boot storage device 201 for booting. After the booting action of the electronic device has been completed, the second CPU C_2 may read the information stored in the normal storage device 203 to control the electronic device 200. In one embodiment, an OS such as windows, android or IOS is installed to the normal storage device 203. After the booting action of the electronic device has been completed, the second CPU C_2 may control the electronic device 200 via the OS. In another embodiment, one of the CPUs may perform the booting action first, and then activate other CPUs after the booting action is completed.

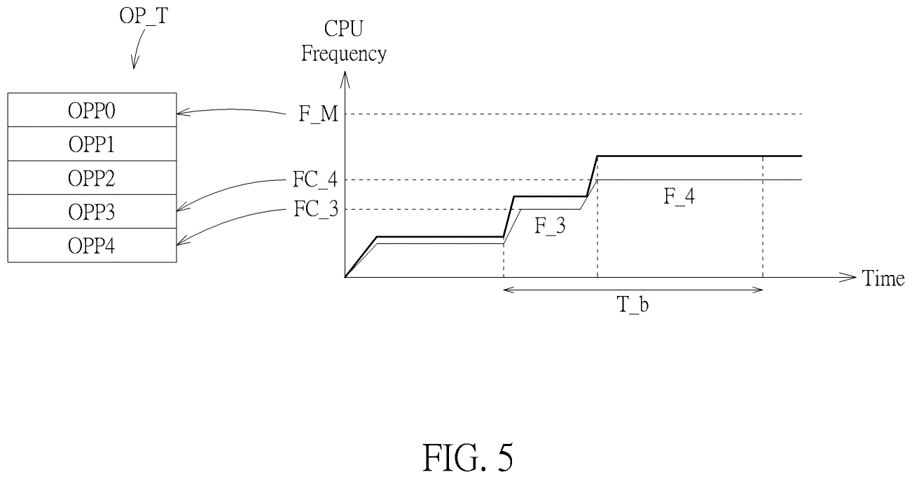

FIG. 5 is a schematic diagram illustrating a second CPU frequency of the embodiment shown in FIG. 4. The curve of the first CPU C_1 is also illustrated in FIG. 5, but the first frequency ceiling FC_1 and the second frequency ceiling FC_2 are not marked for the convenience of explanation. The same as FIG. 3, in the embodiment of FIG. 5, the horizontal axis represents time, and the vertical axis represents the CPU frequency. The supply voltage of the second CPU C_2 may vary corresponding to the variation of the second CPU frequency. In one embodiment, the second CPU C_2 may operate in different CPU levels which correspond to different combinations of CPU frequencies and supply voltages.

In the embodiment of FIG. 5, the electronic device 200 is initially turned off, in which the second CPU frequency may be zero, but such state is not illustrated in FIG. 5. After receives a booting instruction, the electronic device 200 boots in the booting time interval T_b, and a booting action of the electronic device 200 has been completed after the booting time interval T_b. In the booting time interval T_b, the second CPU frequency of the second CPU C_2 is a third frequency F_3 which is limited to be lower or equal to a third frequency ceiling FC_3. The second CPU frequency may be a fourth frequency F_4 which is not limited by the third frequency ceiling FC_3 after the frequency adjusting process is performed. The fourth frequency F_4 may also be limited to be lower than or equal to a third frequency ceiling FC_4. The third frequency ceiling FC_3 may be the same as the first frequency ceiling FC_1, and the fourth frequency ceiling FC_4 may be the same as the second frequency ceiling FC_2.

The third frequency ceiling FC_3 may be equal to or smaller than the fourth frequency ceiling FC_4. Also, the third frequency ceiling FC_3 and the fourth maximum frequency are lower than a maximum CPU frequency F_M of the second CPU C_2. In one embodiment, the maximum CPU frequency F_M, the third frequency ceiling FC_3 and the fourth frequency ceiling FC_4 correspond to different CPU levels of the OPP table OP_T.

In the embodiment of FIG. 5, the third frequency ceiling FC_3 is lower than the fourth frequency ceiling FC_4. Accordingly, the third frequency ceiling FC_3 corresponding to a CPU level OPP4 lower than a CPU level OPP3 which the fourth frequency ceiling FC_4 corresponds to. Also, the maximum CPU frequency F_M corresponds to a maximum CPU level OPP0. However, if the third frequency ceiling FC_3 is equal to the fourth frequency ceiling FC_4, the third frequency ceiling FC_3 and the fourth frequency ceiling FC_4 may correspond to the same CPU level.

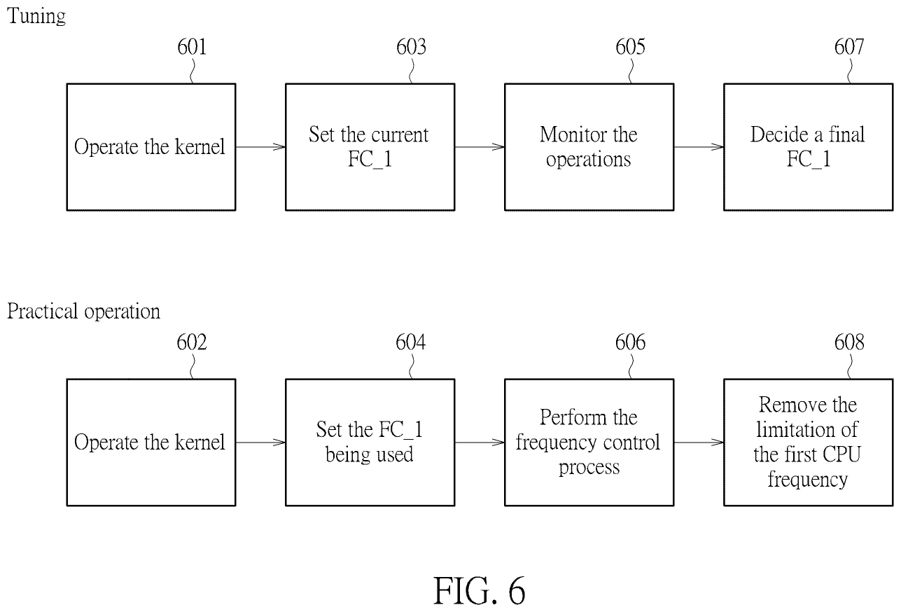

FIG. 6 illustrates a flow chart of tuning the first frequency ceiling FC_1 and a flow chart of practical operations of the electronic device, according to embodiments of the present application. The flow chart of tuning the first frequency ceiling FC_1 comprises:

### Step 601

Operate the kernel of the first CPU C_1.

### Step 603

Set a current first frequency ceiling FC_1.

### Step 605

Monitor the operations of the electronic device 200 related with the current first frequency ceiling FC_1.

As above-mentioned, the first frequency ceiling FC_1 may be set to ensure that the electronic device 200 can smoothly boot, or the first frequency ceiling FC_1 may be set to ensure that the power system of the electronic device 200 is sufficient to support the booting operations.

Accordingly, the booting action of the electronic device 200 or the status of the power system may be monitored to decide whether the current first frequency ceiling FC_1 is proper or not.

### Step 607

Decide a final first frequency ceiling FC_1.

If the monitoring result in the step 605 represents that the current first frequency ceiling FC_1 is proper, the current first frequency ceiling FC_1 is set as the final first frequency ceiling FC_1. Oppositely, if the monitoring result in the step 605 represents that the current first frequency ceiling FC_1 is improper, go back to the step 601 to set the current first frequency ceiling FC_1 to another value.

The flow chart of practical operations of the electronic device comprises:

### Step 602

Operate the kernel of the first CPU C_1.

### Step 604

Set the final first frequency ceiling FC_1 in the step 607 as the first frequency ceiling FC_1 in use. Then, performs the booting action via the first frequency ceiling FC_1 in use, such as the embodiment shown in FIG. 2.

### Step 606

Perform the frequency adjusting process to control the first CPU frequency, such as the embodiment shown in FIG. 2.

### Step 608

Remove the limitation of the first CPU frequency, that is, the frequency adjusting process can control the first CPU frequency to be higher than the first frequency ceiling FC_1 in use.

The tuning of the second frequency ceiling FC_2, the third frequency ceiling FC_3, and the fourth frequency ceiling FC_4 may also follow the steps illustrated in FIG. 6.

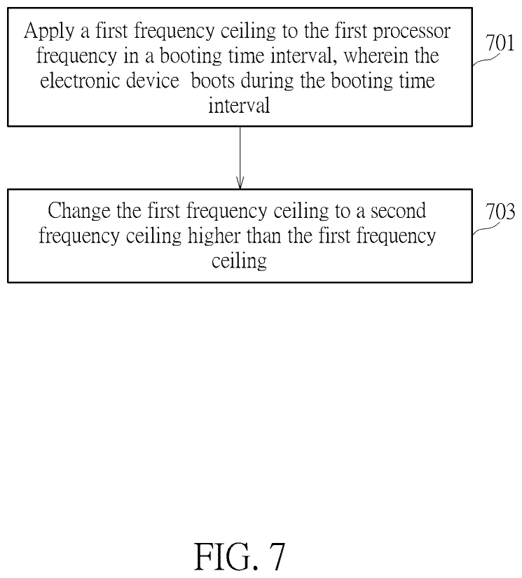

As stated above, the CPU may be replaced by any other processor. Accordingly, a processor frequency control method may be acquired in view of above-mentioned embodiments. The processor frequency control method is for controlling a first processor frequency of a first processor of an electronic device (e.g., the electronic device 200 in FIG. 2). FIG. 7 is a flow chart illustrating a processor frequency control method, according to one embodiment of the present application, which comprises followings steps:

### Step 701

Apply a first frequency ceiling (e.g., the first frequency ceiling FC_1 in FIG. 2) to the first processor frequency in a booting time interval (e.g., the booting time interval T_b in FIG. 2), wherein the electronic device boots during the booting time interval

### Step 703

Change the first frequency ceiling to a second frequency ceiling (e.g., the second frequency F_2 in FIG. 2) higher than the first frequency ceiling.

The first frequency ceiling and the second frequency ceiling are lower than a maximum processor frequency of the processor

[symbol]

The steps illustrated in FIG. 7 corresponding to the embodiment of FIG. 2 and FIG. 3. If the processor frequency control method corresponds to the embodiments of FIG. 4 and FIG. 5, it may further comprise: applying a third frequency ceiling (e.g., the third frequency ceiling FC_3 in FIG. 5) to the second processor frequency in the booting time interval; and changing the third frequency ceiling to a fourth frequency ceiling (e.g., the fourth frequency ceiling FC_4 in FIG. 5) higher than the third frequency ceiling. The third frequency ceiling and the fourth frequency ceiling are lower than the maximum processor frequency.

The number of CPUs contained in the electronic device 200 is not limited to the above-mentioned examples. All CPUs may follow the rules stated in above-mentioned embodiments.

In view of above-mentioned embodiments, the CPU frequency of at least one CPU may be limited below a proper frequency during a booting action. By this way, the instantaneous maximum power consumption of the CPU during the booting action can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processor frequency control method, for controlling a first processor frequency of a first processor of an electronic device, comprising:
(a) applying a first frequency ceiling to the first processor frequency in a booting time interval, wherein the electronic device boots during the booting time interval; and
(b) changing the first frequency ceiling to a second frequency ceiling higher than the first frequency ceiling;
wherein the first frequency ceiling and the second frequency ceiling are lower than a maximum processor frequency of the processor.

2. The processor frequency control method of claim 1, wherein the maximum processor frequency is a maximum processor frequency of an OPP (Operating Performance Points) table of the first processor, wherein the first frequency ceiling is a processor frequency of the OPP table.

3. The processor frequency control method of claim 2,
wherein the OPP table comprises a plurality of processor levels corresponding to different processor frequencies;
wherein the maximum processor frequency corresponds to a maximum processor level of the OPP table of the first processor;
wherein the first frequency ceiling corresponds to a processor level of the OPP table, wherein the processor level is lower than the maximum processor level.

4. The processor frequency control method of claim 1,
wherein a frequency adjusting process is performed to change the first frequency ceiling to the second frequency ceiling.

5. The processor frequency control method of claim 4,
wherein the first processor is a CPU (central processing unit);
wherein the frequency adjusting process is a DVFS(Dynamic Voltage and Frequency Scaling).

6. The processor frequency control method of claim 1,
wherein the electronic device comprises an OS (operating system) installed therein;
wherein the OS is not activated and cannot control the electronic device during the booting time interval;
wherein the OS is activated and is used to control the electronic device 100 after the booting action has been completed.

7. The processor frequency control method of claim 1, wherein the first frequency ceiling is lower than or equal to the second frequency ceiling.

8. The processor frequency control method of claim 1, wherein the electronic device further comprises a second processor, wherein the processor frequency control method further comprises:
(c) applying a third frequency ceiling to the second processor frequency in the booting time interval; and
(d) changing the third frequency ceiling to a fourth frequency ceiling higher than the third frequency ceiling;
wherein the third frequency ceiling and the fourth frequency ceiling are lower than the maximum processor frequency.

9. The processor frequency control method of claim 8,
wherein the maximum processor frequency corresponds to a maximum processor level of the OPP table of the second processor;
wherein the third frequency ceiling corresponds to a processor level of the OPP table, wherein the processor level is lower than the maximum processor level.

10. The processor frequency control method of claim 8, wherein the first processor and the second processor are CPUs, wherein the first processor is a big core and the second processor are different types of cores.

11. An electronic device, comprising:
a first processor, configured to perform following steps:
(a) applying a first frequency ceiling to the first processor frequency in a booting time interval, wherein the electronic device boots during the booting time interval, ; and
(b) changing the first frequency ceiling to a second frequency ceiling higher than the first frequency ceiling;
wherein the first frequency ceiling and the second frequency ceiling are lower than a maximum processor frequency of the processor.

12. The electronic device of claim 11, wherein the maximum processor frequency is a maximum processor frequency of an OPP (Operating Performance Points) table of the first processor, wherein the first frequency ceiling is a processor frequency of the OPP table.

13. The electronic device of claim 12,
wherein the OPP table comprises a plurality of processor levels corresponding to different processor frequencies;
wherein the maximum processor frequency corresponds to a maximum processor level of the OPP table of the first processor;
wherein the first frequency ceiling corresponds to a processor level of the OPP table, wherein the processor level is lower than the maximum processor level.

14. The electronic device of claim 11,
wherein a frequency adjusting process is performed to change the first frequency ceiling to the second frequency ceiling.

15. The electronic device of claim 14,
wherein the first processor is a CPU;
wherein the frequency adjusting process is a DVFS.

16. The electronic device of claim 11,
wherein the electronic device comprises an OS installed therein;
wherein the OS is not activated and cannot control the electronic device during the booting time interval;
wherein the OS is activated and is used to control the electronic device 100 after the booting action has been completed.

17. The electronic device of claim 11, wherein the first frequency ceiling is lower than or equal to the second frequency ceiling.

18. The electronic device of claim 11, wherein the electronic device further comprises a second processor, wherein the second processor performs following steps:
(c) applying a third frequency ceiling to the second processor frequency in the booting time interval; and
(d) changing the third frequency ceiling to a fourth frequency ceiling higher than the third frequency ceiling;
wherein the third frequency ceiling and the fourth frequency ceiling are lower than the maximum processor frequency.

19. The electronic device of claim 18,
wherein the maximum processor frequency corresponds to a maximum processor level of the OPP table of the second processor;
wherein the third frequency ceiling corresponds to a processor level of the OPP table, wherein the processor level is lower than the maximum processor level.

20. The electronic device of claim 18, wherein the first processor and the second processor are CPUs, wherein the first processor is a big core and the second processor are different types of cores.
